(19) United States
(12) Patent Application Publication
(10) Pub. No.: US 2023/0038259 A1
(43) Pub. Date: Feb. 9, 2023

(54) SOLAR TRACKER

(71) Applicant: SOLTEC INNOVATIONS, S.L., Molina de Segura (ES)

(72) Inventors: Francisco Javier CARPIO OBRE, Barcelona (ES); Juan José MALDONADO NICOLÁS, Asturias (ES)

(73) Assignee: SOLTEC INNOVATIONS, S.L., Molina de Segura (ES)

(21) Appl. No.: 17/785,158

(22) PCT Filed: Dec. 16, 2020
(86) PCT No.: PCT/EP2020/086447

§ 371 Date: Jun. 14, 2022

(30) Foreign Application Priority Data
Dec. 16, 2019 (EP) 19383119.5

(51) Int. Cl. H02S 20/32

(52) U.S. Cl. CPC H02S 20/32

(57) ABSTRACT

A solar tracker provides sun tracking to solar panels, and includes several gearboxes for one single motor. In an embodiment, the solar tracker includes a torsion beam. defining a longintudinal direction of rotation and rotating the solar panels; motor, with motor shaft; first gearbox, at torsion beam at first position, and connected to motor shaft for transmitting to torsion beam rotation of motor shaft; second (Tarbox, mounted to torsion beam at second position further from motor than first position; and primary shaft, coaxial to motor shaft, and connected to second gearbox, for transmitting to second gearbox rotation of the motor shaft. Gearboxes define embedments withstanding torsion moment caused by wind loads for restricting rotation of torsion beam. It provides higher resistance to wind loads and allows for longer solar trackers.

### TECHNICAL FIELD OF THE INVENTION

The present invention belongs to the technical field of solar energy, in particular to solar trackers, for providing rotation to a module of solar panels for sun-tracking. In particular, the object of the invention relates to such a solar tracker.

### BACKGROUND OF THE INVENTION (STATE OF THE ART)

Wind is a main factor affecting the integrity of solar trackers, because it may produce collapsing of the solar trackers. Firstly, dynamic action of wind on the modules of solar panels (for example, photovoltaic panels) produces a torsion moment which mainly affects the tracker shaft and the reducer gearbox of the solar tracker. Secondly, fluctuating wind loads provoke resonance effects on the structure of the solar tracker causing also a structural instability leading the structures to a quicker collapse.

With the purpose of reducing the effect of resonance and dynamic loads provoked by the wind, several solutions have been proposed.

One of the solutions is to reduce the length of the solar tracker, leading to a reduced number of solar panels exposed to wind action and, therefore, the torsion moment which the structure of the solar tracker has to withstand.

Currently, trackers support 45 panels with one single reducer gearbox, the gearbox being intended for two main functions:
Acting as an embedment, i.e. restricting the rotation degree of freedom and, therefore, absorbing all the torsion moment that the wind produces on the structure.
Providing motion to the structure for sun-tracking.

Document US 2017/0353146 A1 (SunDrive Technologies, LLC) discloses modular tracker systems that include at least first and second tables or are continuous without the use of tables, a single motor driving the first and second tables, first and second intra-table drive shafts and an inter-table drive shaft, without a torque tube. Each table includes a support structure including first and second mounting posts, a frame supported by the support structure, at least one solar panel supported by the frame. and first and second gearboxes being concentrically aligned for each table. The first and second gearboxes are each configured to produce first and second outputs. The first output has a first rotational speed, and the second output has a second rotational speed less than the first rotational speed, and is operatively coupled to the frame. The inter-table drive shaft couples the second gearbox of the first table with the first gearbox of the second table, whereby the first and second tables are rotated synchronously.

There is a current need for obtaining solar trackers with improved performance, regarding length of the trackers and capability of resisting torsion moments due to wind loads.

### SUMMARIZED DESCRIPTION OF THE INVENTION

The present invention relates to a solar tracker for providing sun tracking to a module of solar panels by rotation of a torsion beam, the solar panel comprising more than one gearbox for each single motor, as will be explained below.

Through inclusion of several gearboxes in one same tracker, a longer solar tracker structure, with reduced wind torsion, is achieved. In particular, rotation due to the effect of wind loads is reduced in an intermediate portion of the tracker, located between gearboxes, wherein at both ends of each central portion each gearbox constitutes an embedment, so that rotation caused by the wind loads is not permitted at the positions where the gearboxes are located, the gearboxes thereby absorbing all the torsion moment caused by the wind loads.

Furthermore, since rotation, due to the wind loads, is zero, i.e., it is absorbed by the gearboxes, at the location of the gearboxes, the solar tracker is allowed to further include outer portions starting each at a gearbox and extending to a corresponding free end, wherein the rotation induced by the wind loads is reduced in the outer portions. As a consequence, longer solar trackers are obtained with reduced rotation induced by wind loads, as well as the performance of the motion transmission is notably improved, with respect to trackers based on a gearwheel and worm gear transmission.

Some commercial examples of suitable gearboxes are listed below.
Armonic Nidec Shimpo Flexwave WP series and ER-P series.
Neugart epyciclyc gearbox
Coaxial gearbox
Cycloidal gearboxes

### BRIEF DESCRIPTION OF THE DRAWINGS

The advantages mentioned above, as well as other advantages and features of the present invention, shall be better understood with reference to the following detailed description of a preferred embodiment of the invention, with due regard to the attached set of figures, which are to be construed in an illustrative, non-limitative manner, and wherein:

FIG. 1 shows a view of a solar tracker according to the state of the art, wherein said solar tracker has been reduced in length so as to support 30 panels instead of 45 panels.

FIG. 2 shows a view of a 60-panel solar tracker exemplifying the solar tracker of the present invention.

FIG. 3 shows an enlarged view of the motor, the first gearbox and the primary shaft, in a preferred embodiment in which the motor shaft passes through the first gearbox and is connected at a free end thereof to the primary shaft.

FIG. 4 shows an enlarged view illustrating leaning supports located along the primary shaft and the torsion tube.

FIG. 5 shows an enlarged view of the leaning supports located at the connections of the tube portions making up the torsion tube.

FIG. 6 shows an enlarged view of the second gearbox and the primary shaft.

### DETAILED DESCRIPTION OF A PREFERRED EMBODIMENT OF THE INVENTION

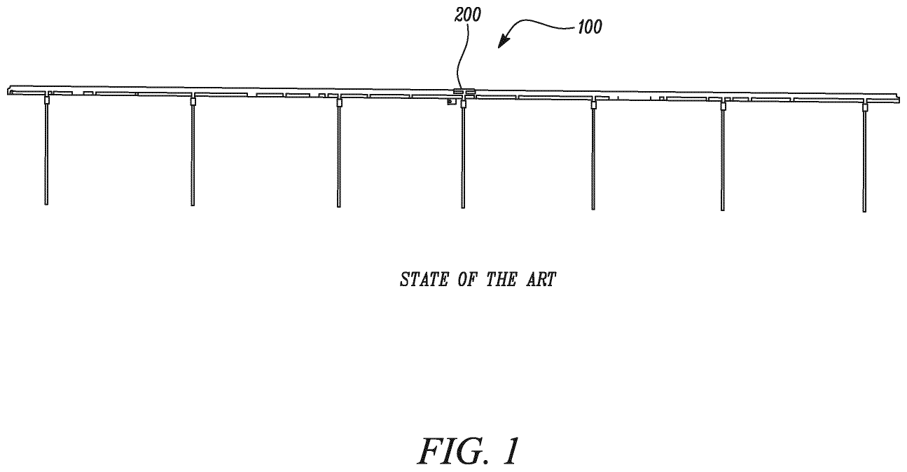

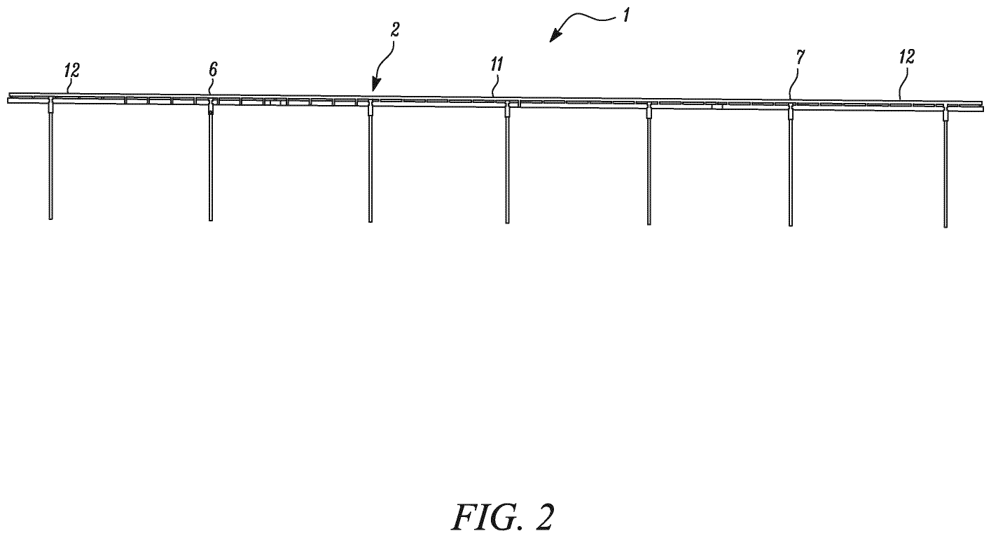

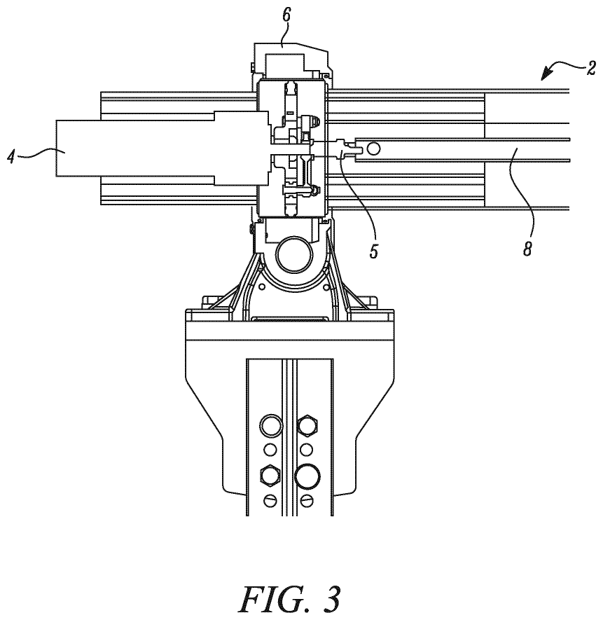

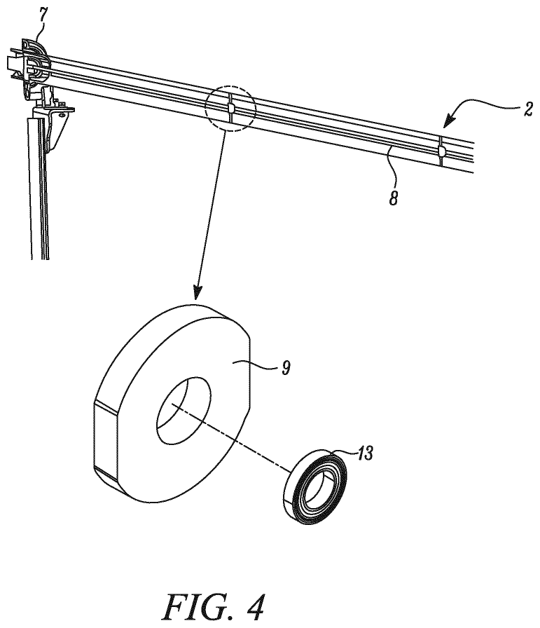

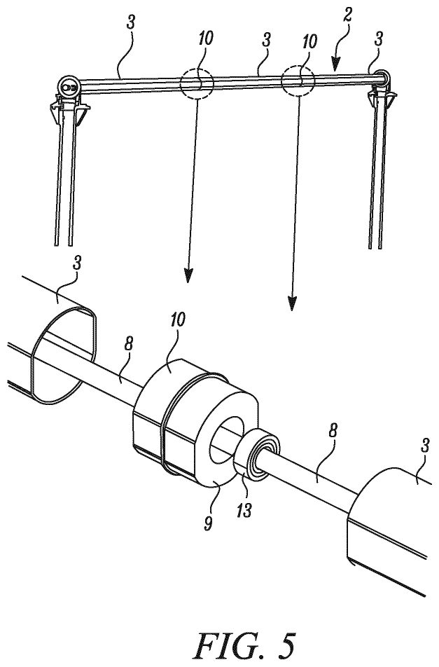

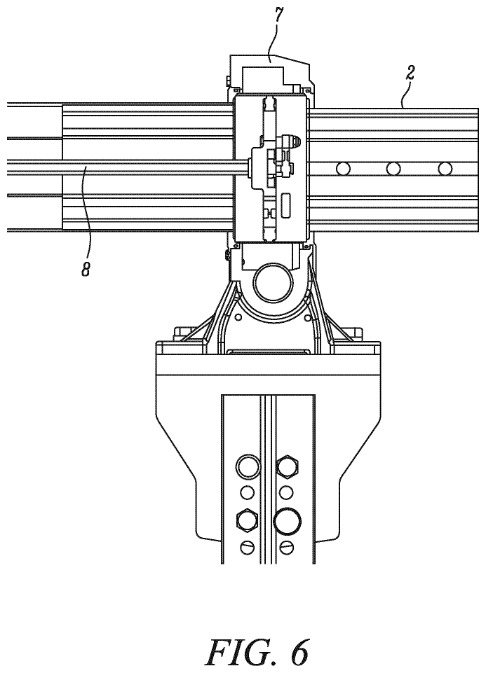

Next a detailed description of a preferred embodiment of the solar tracker (1) of the invention shall be provided, with the help of FIGS. 1-6 mentioned above.

The solar tracker (1) comprises a torsion beam (2), for providing sun-tracking rotation to a module of solar panels (not shown). The torsion beam (2) is configured so as to define a longitudinal direction around which the torsion beam (2) is to be rotated. The torsion beam (2) may be a torsion tube (2), in particular of the type made by several tube portions (3) which are adjacently connected. The solar tracker (1) also includes a motor (4), such as an electric motor (4), which comprises a rotatable motor shaft (5), which is oriented along the longitudinal direction of rotation. As explained below, the solar tracker (1) further comprises at least a first gearbox (6) and a second gearbox (7).

The first gearbox (6) is mounted to the torsion beam (2) at a first position nearer the motor (4), and connected to the motor shaft (5) for transmitting to the torsion beam (2) the rotation of the motor shaft (5), whereas the second gearbox (7) is mounted to the torsion beam (2) at a second position which is, along the longitudinal direction, further from the motor (4) than the first position.

The solar tracker (1) further comprises a primary shaft (8), coaxial to the motor shaft (5), and connected to the second gearbox (7) for transmitting to the second gearbox (7) the rotation of the motor shaft (5).

The first gearbox (6) and the second gearbox (7) are configured and mounted so as to define corresponding embedments withstanding torsion moment caused by wind loads for restricting rotation of the torsion beam (2) at their corresponding positions due to the wind loads.

The primary shaft (8) is also connected to the motor shaft (5) for transmitting the rotation of the motor shaft (5) to the second gearbox (7). Therefore, the rotation of the motor shaft (5) is transmitted both to the first gearbox (6) as well as to the primary shaft (8) which is connected to the second gearbox (7). Both gearboxes (6, 7) are preferably identical. Two possibilities are considered for transmitting the rotation from the motor shaft (5) to the primary shaft (8).
The motor shaft (5) is passing through the first gearbox (6) and on the other side is connected to the primary shaft (8).
An additional connection part (not shown) connects the first gearbox (6) to the primary shaft (8) maintaining the same rotation speed than the motor shaft (5). So as to make the primary shaft (8) rotate at the same speed as the motor shaft (5), the additional connection, may be any conventional means, such as a cotter and cotter pin mechanism, connecting an input shaft (not shown) of the first gearbox (6) to the primary shaft (8).

Along the primary shaft (8), leaning supports (9), for example, with bearings (13) and / or bushings (not shown) may be located for supporting the primary shaft (8), thereby providing correct alignment to the primary shaft (8). In the case that, as explained above, the torsion beam (2) comprises a torsion tube (2) made up of a plurality of coaxial tube portions (3) adjacently connected, the leaning supports (9) may be located also at connections (10) between any two adjacent tube portions (3).

The motor (4) is preferably housed within the torsion beam (2). The same applies to the primary shaft (8). The inclusion of any such elements within the torsion beam (2) reduces, even avoids, interferences with other elements of the solar tracker (1). The gearboxes (6, 7) are connected to the torsion beam (2).

The motor (4) and the first gearbox (6) are preferably integrated making part of one gearmotor system.

It has been tested that, with respect to one current 45-panel solar tracker (100) according to the state of the art, as shown on FIG. 1, a length reduction of 30% has led, under torsion caused by wind loads, to a reduction of 40% in torsion moment and 55% in rotation at the free ends. As a conclusion, by reducing in approximately one third the length of the solar tracker (100), an improved structural behavior under dynamic wind actions is obtained, which leads to the possibility of, starting with the above referred 45-panel solar tracker (100), producing 30-panel solar trackers with one single gearbox (200). One step forward led to defining the 60-panel solar tracker (1) according to the invention, by considering two gearboxes (6, 7) for one same motor (4), thereby providing the same effect or reducing the effects of wind loads than two 30-panel trackers (100), so that all advantages obtained through such a 30-panel solar tracker (100) configuration are kept for a 60-panel solar tracker (1), the main advantage being an economic saving. The 60-panel solar tracker (1) exemplified by the invention comprises a 30-panel intermediate portion (11), located between the first gearbox (6) and the second gearbox (7), and two 15-panel outer portions (12) starting from each corresponding gearbox (6, 7) and extending up to the corresponding free ends (13).

Longer solar trackers (1) may be made according to the invention. In particular, two possibilities are considered to that end:

1) If the wind conditions allow so, the above referred solar tracker (1) may include longer portions (11, 12), i.e. portions (11, 12) comprising a higher number of solar panels; or

2) The solar tracker (1) may additionally include one or several additional gearboxes (not shown), each one additional gearbox(es) being located subsequently further than the second gearbox (7) and, as the case might be, a corresponding immediately previous additional gearbox respectively, wherein any additional gearbox is connected to the second gearbox (7) or, as the case might be, the corresponding immediately previous additional gearbox, by means of a motor rotation transmission system, for example, additional shafts (not shown).

1. A solar tracker for providing sun tracking to a module of solar panels, the solar tracker comprising:
a torsion beam for providing rotation to the module of solar panels, the torsion beam defining a longitudinal direction of rotation:
a motor with a rotatable motor shaft along the longitudinal direction:
a first gearbox, mounted to the torsion beam at a first position nearer the motor, and connected to the motor shaft for transmitting to the torsion beam the rotation of the motor shaft:
a second gearbox mounted to the torsion beam at a second position which is, along the longitudinal direction, further from the motor than the first position: and a primary shaft coaxial to the motor shaft, and connected to the second gearbox, for transmitting to the second gearbox the rotation of the motor shaft:
wherein the first gearbox and the second gearbox are configured and mounted so as to define corresponding embedments withstanding torsion moment.

2. The solar tracker according to claim I. wherein the primary shaft is connected to the motor shaft, which is passing through the first gearbox.

3. The solar tracker according to claim 1, further comprising an additional connection part connected to an input shaft of the first gearbox and to the primary shaft for maintaining in the primary shaft a same rotation speed than in the motor shaft.

4. The solar tracker according to claim I. further comprising leaning supports along the primary shaft for supporting and aligning the primary shaft.

5. The solar tracker according to claim 1, wherein the torsion beam is a hollow torsion tube.

6. The solar tracker according to claim 5, wherein the torsion tube is made of a plurality of adjacently-connected coaxial tube portions.

7. The solar tracker according to claim 6, wherein the leaning supports are located at the connections of the tube portions.

8. The solar tracker according to claim 1. wherein the motor is housed within the torsion tube.

9. The solar tracker according to claim 1, wherein the first gearbox is connected to the torsion tube.

10. The solar tracker according to claim 7, wherein the motor and the first gearbox are intecYrated making part of a aearmotor system.

11. The solar tracker according to claim 1 wherein the second gearbox is connected to the torsion tube.

12. The solar acker according to claim 1. wherein the primary shaft is housed within the torsion tube.

13. The solar tracker according to claim 1, further comprising at least one additional fYearbox the at least one additional gearbox being located subsequently further than the second gearbox and, as the case might be, a corresponding immediately previous additional gearbox respectively,
wherein any additional gearbox is connected to the second gearbox using a motor rotation transmission system or the corresponding immediately previous additional gearbox using a motor rotation transmission system. and
wherein the at least one additional gearbox defines a corresponding embedment withstanding torsion moment.
